(19) United States
(12) Patent Application Publication
(10) Pub. No.: US 2020/0113126 A1
(43) Pub. Date: Apr. 16, 2020

(54) Agricultural Method

(71) Applicant: 7108789 Manitoba Inc., Winnipeg (CA)

(72) Inventor: Erik Eising, Winnipeg (CA)

(21) Appl. No.: 16/595,140

(22) Filed: Oct. 7, 2019

Related U.S. Application Data
(60) Provisional application No. 62/743,605, filed on Oct. 10, 2018.
(60) Provisional application No. 62/743,609, filed on Oct. 10, 2018.
(60) Provisional application No. 62/743,611, filed on Oct. 10, 2018.
(60) Provisional application No. 62/743,619, filed on Oct. 10, 2018.
(60) Provisional application No. 62/743,622, filed on Oct. 10, 2018.
(60) Provisional application No. 62/797,614, filed on Jan. 28, 2019.

(51) Int. Cl. A01C 7/20; A01C 5/06; G05D 27/02; G06Q 50/02; A01B 15/18

(52) U.S. Cl. CPC A01C 7/203; A01C 5/064; A01B 15/18; G06Q 50/02; G05D 27/02

(57) ABSTRACT

Depth of penetration of a soil coulter is obtained using a sensor being mounted on the side of the disk adjacent the edge such that the sensor as the disk rotates is located above the surface of the soil during a first part of its rotation and is located below the surface during a second part of its rotation. This sensor is also used to detect characteristics of material outside the coulter as it rotates and temperature. This data is used in a growth model to generate predicted growth data to allow control of growth remediation materials to the crop.

This application claims the benefit under 35 USC 119 (e) of the following provisional applications, the disclosures of which are incorporated herein by reference:

Application 62/743,605 filed Oct. 10 2018:

Application 62/743,609 filed Oct. 10 2018:

Application 62/743,611 filed Oct. 10 2018:

Application 62/743,619 filed Oct. 10 2018:

Application 62/743,622 filed Oct. 10 2018:

Application 62/797,614 filed Jan. 28 2019:

This invention relates to an agricultural method which can be used in a number of different aspects. In one aspect there is provided a method for managing growth of crops in a soil bed which includes an arrangement using a coulter of the type comprising a disk, the edge of which cuts into a bed of material to a depth determined by the pressure on the coulter and the characteristics of the material over which the coulter is running.

The arrangement herein can use the arrangement shown in U.S. Pat. No. 9,891,155 issued Feb. 13, 2018 by the inventor herein which discloses a soil coulter to carry a soil sensor for analyzing soil quality and constituents.

### SUMMARY OF THE INVENTION

According to one aspect of the invention there is provided a method for managing growth of crops in a soil bed comprising:

providing a computer processor having an input and output for data;

using the computer processor to operate a crop growth model which includes inputs from the data input and provides data output;

during a seeding operation for application of seeds to the soil bed operating a soil coulter for soil penetration by rolling the soil coulter along the soil bed, the soil coulter comprising:
a disk having a peripheral edge and two spaced side walls extending from the peripheral edge toward a center of the disk;
a hub mounting the disk for rotation about an axis of the disk so that the peripheral edge rotates in the soil and the coulter penetrates the soil to a depth below a surface of the soil;
a detector responsive to electromagnetic radiation from material adjacent the coulter disk for emitting a detector signal related to the radiation, the sensor being mounted at one side wall of the disk for rotation therewith;
the detector being mounted on the disk at a position thereon adjacent the edge such that the sensor as the disk rotates is located above the surface of the soil during a first part of its rotation and is located below the surface during a second part of its rotation;

obtaining from said detector signal soil constituent data related to constituents of the soil bed during said seeding operation and inputting said soil constituent data into the data input of the computer processor;

obtaining from said detector signal data related to a temperature of the soil bed during said seeding operation and inputting said temperature data into the data input of the computer processor;

during a growing season inputting into the data input of the computer processor data related to weather conditions existing during the growing season at the soil bed;

using the crop growth model to generate from the soil constituent data, the temperature data and the data related to weather conditions to generate output data indicative of a state of growth of the crop during the growing season;

and using the output data to apply at least one crop growth remediation product to the crop and/or the soil bed during the growth season.

Preferably the weather conditions are obtained from weather station data. However the weather conditions can also or alternatively be obtained from local weather detectors located adjacent the soil bed concerned such as in a field, since these can much more accurately detect the amount of rainfall and sunshine at a specific location which may vary very locally.

Preferable further input data provided to the processor for use in the model relates to historical crop yield data.

Preferable further input data provided to the processor for use in the model relates to visual images of a crop taken for example by satellite or drone.

Preferably the coulter carries a temperature sensor arranged to engage the soil as the coulter rotates in the soil bed.

Preferable further input data provided to the processor for use in the model include one or more of:

Historical weather data;

real time recorded weather data collected at or near field location during the crop growing season;

satellite imaging data related to crop canopy development during crop growing season once crop has emerged.

Preferably the coulter is actively used in the seeding system so that there is provided a control system responsive to the signal to calculate the depth of penetration of the coulter in the soil and an assembly for changing a depth of application of the seeds to the soil bed depending on the measured depth. However the coulter may be entirely separate from the seeding system and transported separately, or it may be carried on the same seeding apparatus but not used in controlling the seeding action.

Preferably the coulter is part of the seeding system so that a downward pressure on the disk can be increased or decreased so as to change a depth of penetration of the coulter disk and hence a depth of the application of the seeds.

Preferably the remediation product comprises any one of:

Water irrigation to provide a variable rate irrigation.

Fertilizer. Fertilizer application can be split where the system does not apply all fertilizer at once, but it is spread out over the crop season when crop requires certain nutrients at certain stage of development. This can be used to provide variable rate fertilizer application when crop is developing;

Chemicals. This can include fungicide, herbicide, insecticide all of which can be controlled at variable rate.

Preferably the soil constituents detected comprise one or more of N, P, K, soil moisture, organic matter, pH, Electrical Conductivity (EC), sand and clay content. These nine constituents are currently predicted through the system. Other constituents also may be included and some of them may be omitted. The selection of constituents can be dependent on the model and the inputs required therefor. Temperature measurement is included, not through spectroscopy but by a separate embedded high-speed thermometer carried on the coulter or on another location.

Preferably the sensor is arranged to provide data relating to the characteristics of the soil when the sensor is below the soil surface and the controller calculates the maximum depth of penetration of the coulter at the sensor so as to determine by the sensor characteristics of the soil at calculated depths.

Preferably the sensor feeds the data to an analysis system to obtain an analysis of the characteristics of the soil from the surface to the maximum depth as the depth of the sensor varies as the sensor rotates with the coulter.

In one arrangement the sensor detects a reflected beam.

In one arrangement the controller is adapted to calculate from the signal a first time when the sensor enters below the soil surface and a second time when the sensor departs the soil surface and to calculate from the first and second times the depth of penetration of the coulter in the soil.

In one arrangement the detector system is responsive to both reflected electromagnetic radiation from a source inside the coulter disk and to transmitted electromagnetic radiation from a source outside the coulter disk.

Preferably the coulter disk carries a first detector responsive to electromagnetic radiation from a source inside the coulter disk and a second detector responsive to transmitted electromagnetic radiation from a source outside the coulter disk.

Preferably the detector includes a component mounted within the coulter disk and a transparent window at the side wall so as to receive electromagnetic radiation passing through the transparent window in the side wall of the coulter disk.

Preferably the first detector is mounted at a first transparent window and the second detector is mounted at a second transparent window.

Preferably there is provided a source of electromagnetic radiation mounted outside the coulter disk for transmitting the electromagnetic radiation inwardly to said detector.

While only transmitted radiation from an outside source can be used in some cases, more typically there is also provided a source of electromagnetic radiation mounted inside the coulter disk for transmitting the electromagnetic radiation outwardly to the bed of material for reflecting therefrom.

That is preferably the detector system is responsive to both reflected electromagnetic radiation from the source inside the coulter disk and to transmitted electromagnetic radiation from the source outside the coulter disk.

In one arrangement the coulter disk carries a first detector responsive to electromagnetic radiation from a source inside the coulter disk and a second detector responsive to transmitted electromagnetic radiation from a source outside the coulter disk. However a single detector can carry out both functions.

As set forth above, preferably the detector includes a component mounted within the coulter disk and a transparent window at the side wall so as to receive electromagnetic radiation passing through the transparent window in the side wall of the coulter disk.

Where separate detectors are used, preferably the first detector is mounted at a first window and the second detector is mounted at a second window.

The objective herein is therefore to have the constituent data become the main driver of a crop growth model in real time. Such crop growth models have been developed primarily for analysis of the impact of climate change on crop yield.

Scientist developed mathematical models that use data collected on site at Research Farm locations. Stationary data, as temp, participation, evaporation, soil composition, fertility. The developed software is open source.

Thus using the present method, at seeding time we have the critical data that forms the in-put starting point for crop modeling.

One objective with the real time crop growth model is to provide the farmer at any given time during the crop production season an update of challenges for reaching the full yield potential of his crop.

The method disclosed herein can be used to collect data at micro level to not only deliver yield projections but also the stage of plant development in a grid pattern per field. It is preferred to use both crop growth and crop yield. Phenological development provides information at different stages of crop growth. This combined with meteorological information allows the method to make recommendations from when to spray against insects in canola, which is an issue at early growth stage, to fungus infection of the flagleaf of wheat which is an issue at last crop development stage. Crop yield potential is the bench mark that farmers will use in their go or no-go decision for applying crop protection products or split fertilizer.

So far, the industry is reactive to situations that develop during crop season However the accurate and effective data obtained in this system can be used to deliver proactive advice by identifying crop production challenges and their impact.

The industry uses weather station data, historical crop yield data and satellite images of crop canopy to alert the farmer of crop issues which are all reactive processes.

At seeding time the method provides information on what seeds will encounter during germination and emergence. The method acts to add existing weather station data and satellite data collected during the crop production season and can model in real time the crop growth at every farmers field, when using the critical real time data obtained by the present method.

Crop models provide a mechanistic method to estimate the interaction of spatial differences in soil properties and pest populations with temporal stresses on yield variability within a field. This is possible because the models compute daily growth processes as a function of weather, stress, and pest damage. Once calibrated to simulate the historical yield variability within a field, crop models are a powerful tool to develop risk management strategies that can balance economic risk incurred by the producer with environmental risks that impact society. The Apollo system incorporates many procedures that crop modelers have developed to analyze causes of yield variability and to estimate economic and environmental consequences of prescriptions into a simple interface. Because Apollo is designed essentially as a shell program to run the DSSAT model, it would be a useful methodology for any spatially variable application of DSSAT, provided spatially variable input data (such as soils or yield data) is available. Thus, while the development and application presented was for simulation of corn production in central Iowa, the methodology is applicable for any location in which one wishes to use DSSAT for spatial simulation. Because the code for the functions beyond automated generation of the spatially variable inputs and yield files were written to interface with DSSAT, version 3.5, some recoding will be necessary before the code can be used with DSSAT, version 4.0 and beyond, due to the change in structure of the cropping systems model. Among other benefits, compatibility with DSSAT 4.0 and beyond would allow for using Apollo in simulations and analysis of crop rotations, which is not supported in DSSAT 3.5. Code for the beta version of Apollo can be obtained free of charge from the corresponding author.

Other suitable models can be used for example any one of the following:

DSSAT which is disclosed at https://dssat.net/about. The Decision Support System for Agrotechnology Transfer (DSSAT) is a software application program that comprises crop simulation models for over 42 crops (as of Version 4.7) as well as tools to facilitate effective use of the models. The tools include database management programs for soil, weather, crop management and experimental data, utilities and application programs. The crop simulation models simulate growth, development and yield as a function of the soil-plant-atmosphere dynamics.

The DSSAT community is committed to releasing all DSSAT software tools and models under an open software license. As of January, 2018, two minor issues remain concerning ownership of a specific model and one tool. Thus, for the moment, the code is maintained on a private GitHub account.

The DSSAT Cropping System Model (CSM) currently runs under Windows, Linux and Apple operating systems. The DSSAT shell and associated tools are only available for Windows. We are exploring porting the functionality to a platform that would allow use under any of the three operating systems.

AquaCrop Software Developed by the Water and Land division of Food and Agriculture Organization (FAO) of the United Nations. Free down loadable at http://www.fao.org/aquacrop/news/en/.

InfoCrop is available from the Division of Agricultural Physics, Indian Agricultural Research Institute, New Delhi at http://infocrop.iari.res.in/wheatmodel/UserInterface/HomeModule/Default.aspx

APSIM The Agricultural Production Systems simulator (APSIM) is available at:

http://www.apsim.info/

According to a further aspect the invention, which can be used as part of the above method of modelling or can be used independently, there is provided an apparatus for applying a slurry to soil comprising:

a vehicle for movement across the soil;

a coulter disk carried on the vehicle having two side surfaces and an axle frame or hub mounting the coulter disk for rotation such that the coulter disk rotates as it passes along the soil and cuts into the soil;

a detector responsive to electromagnetic radiation from material adjacent the coulter disk for emitting a signal related thereto, the sensor being mounted at one side wall of the disk for rotation therewith;

the detector being mounted on the disk at a position thereon adjacent the edge;

a discharge duct carried on the vehicle for movement with the coulter disk arranged to apply the slurry onto the coulter disk for incorporation into the soil;

the detector system being arranged such that the detector receives electromagnetic radiation from the slurry at a part of the rotation of the coulter disk.

Preferably the detector system is arranged such that the detector receives electromagnetic radiation from the soil at another part of the rotation of the coulter disk.

Preferably the slurry is applied on to the disk at a rear part of the disk relative to forward movement. This application onto the surface of the disk ensures that the slurry is fed into the soil at the bottom or the furrow being formed so as to be incorporated into the soil and mixed with the soil rather than merely deposited on top of the soil.

Preferably the slurry is detected after the detector passes through the soil.

Preferably the detector is arranged to be cleaned as it passes through the soil before reaching the slurry.

Preferably the slurry is applied onto a side of the coulter disk at which the detector is located.

Preferably the slurry is applied by a guide mouth portion of the duct onto the side of the coulter disk on a circular path generated as the coulter rotates where the path contains the detector.

In one arrangement the source of electromagnetic radiation is mounted so as to transmit the electromagnetic radiation through the slurry to the detector.

In this arrangement preferably the source of electromagnetic radiation is mounted on the duct but other locations are possible.

However more preferably the detector system is responsive to both reflected electromagnetic radiation from a source inside the coulter disk and to transmitted electromagnetic radiation from a source outside the coulter disk. In this arrangement preferably the coulter disk carries a first detector responsive to electromagnetic radiation from a source inside the coulter disk and a second detector responsive to transmitted electromagnetic radiation from a source outside the coulter disk.

Preferably the system herein is used to control application rate and the vehicle is arranged to be driven by a drive system at a variable ground speed and there is provided a slurry pump and wherein one or both of the slurry pump and the drive system is arranged to be driven at a rate at least partly dependent on an analysis of the slurry obtained by the detector system.

Preferably the analysis is related to NPK content and/or total solids content although other factors can be determined. In this arrangement preferably the total solids content is measured by transmitted electromagnetic radiation passing through the slurry.

Preferably in all cases described herein, both above and below, the detector includes a component mounted within the coulter disk and a transparent window at the side wall so as to receive electromagnetic radiation passing through the transparent window in the side wall of the coulter disk. However the sensor itself if sufficiently ruggedly constructed can be directly mounted at the wall. The detector which actually measures the incoming light or radiation may be mounted at the window or at the wall or may be mounted at a different location and the incoming light may be collected at the window and transmitted to the remote location for sending and analysis. This the detector may sense the incoming radiation directly or may include a transfer device such as an optical fiber.

According to a further aspect the invention, which can be used as part of the above method of modelling or can be used independently, there is provided an apparatus for measuring constituents in a bed of material comprising:

a coulter disk having two side surfaces and an axle frame mounting the coulter disk for rotation such that the coulter disk rotates as it passes along the material and cuts into the material;

and at least one detector system comprising an electromagnetic radiation detector mounted in a side surface of the coulter disk for rotation with the coulter disk;

and a source of electromagnetic radiation mounted outside the coulter disk for transmitting the electromagnetic radiation inwardly to said detector.

While only transmitted radiation from an outside source can be used in some cases, more typically there is also provided a source of electromagnetic radiation mounted inside the coulter disk for transmitting the electromagnetic radiation outwardly to the bed of material for reflecting therefrom.

That is preferably the detector system is responsive to both reflected electromagnetic radiation from the source inside the coulter disk and to transmitted electromagnetic radiation from the source outside the coulter disk.

In one arrangement the coulter disk carries a first detector responsive to electromagnetic radiation from a source inside the coulter disk and a second detector responsive to transmitted electromagnetic radiation from a source outside the coulter disk. However a single detector can carry out both functions.

As set forth above, preferably the detector includes a component mounted within the coulter disk and a transparent window at the side wall so as to receive electromagnetic radiation passing through the transparent window in the side wall of the coulter disk.

Where separate detectors are used, preferably the first detector is mounted at a first window and the second detector is mounted at a second window.

As set forth herein, the system is typically but not essentially used where a duct is provided for supplying a slurry or other liquid containing particulates at the coulter disk and wherein parameters of the slurry are measured by transmitted electromagnetic radiation passing through the slurry including particularly a total solids content in a slurry external to the coulter disk is measured by transmitted electromagnetic radiation passing through the slurry. This system can use any of the optional features set forth above.

According to a further aspect the invention, which can be used as part of the above method of modelling or can be used independently, a harvesting apparatus comprising:

a crop harvesting header for harvesting a standing crop on a growing medium;

a coulter disk carried on the vehicle in front of the harvesting header;

the coulter disk having two side surfaces and an axle frame mounting the coulter disk for rotation such that the coulter disk rotates as it passes along the growing medium and cuts into the medium;

at least one detector system comprising an electromagnetic radiation detector, a source of electromagnetic radiation, wherein said detector receives electromagnetic radiation after interaction with said material;

wherein the detector is mounted at one side surface of the coulter disk and rotates with the coulter disk;

the coulter disk and the detector being arranged such that the detector as it rotates with the coulter disk receives electromagnetic radiation from the air above top of the standing crop, from within the standing crop and from below the growing medium and generates signals responsive thereto;

and a control system for receiving and analyzing the signals.

Preferably the control system is arranged to calculate from the signals from the air and from the standing crop the height of the standing crop.

Preferably the control system is arranged to calculate from the signals from the standing crop the density of the standing crop. These two calculations of height and density can be used to generate an indication of total crop volume on an ongoing basis which can be tied to GPS to provide yield data.

Preferably also the control system is arranged to calculate from the signals from the standing crop constituents in the standing crop.

Preferably also the control system is arranged to calculate from the signals from the growing medium constituents in the growing medium.

According to a further aspect the invention, which can be used as part o the above method of modelling or can be used independently, there is provided an apparatus for collecting and mixing silage comprising:

a vehicle for movement between a stack of silage and an animal feed location;

the vehicle having a cutting head for cutting into the stack so as to extract a portion of the stack for transportation, the cutting head being mounted on the vehicle for movement relative to the stack in a cutting action;

a conveyor for conveying the cut and extracted portion;

a coulter disk carried on the cutting head for movement therewith in the cutting action;

the coulter disk being mounted so as engage into the silage prior to or with the cutting action so that the coulter disk cuts into a surface of the silage to be cut;

the coulter disk having two side surfaces and an axle frame or hub mounting the coulter disk for rotation such that the coulter disk rotates as it moves along the silage with the cutting head;

a source of electromagnetic radiation mounted within the coulter disk;

a detector responsive to electromagnetic radiation from material adjacent the coulter disk for emitting a signal related thereto, the detector being mounted at one side wall of the disk for rotation therewith;

the detector being mounted on the disk at a position thereon adjacent the edge;

and a control system for measuring constituents in the silage from electromagnetic radiation reflected from the silage.

Preferably the cutter head includes a cutting blade and the coulter disk is mounted on the cutter head in advance of the cutting blade.

Preferably the coulter disk is mounted such that the disk rotates in the direction of movement of the cutting head.

Preferably the coulter disk is driven by a drive motor so as to rotate with the movement of the cutter head.

Preferably the vehicle includes a mixing chamber for mixing the conveyed and cut silage material.

Preferably the vehicle is arranged for mixing the conveyed and cut silage material with an additional material and wherein an amount of the additional material is controlled in response to the measured constituents.

According to a further aspect the invention, which can be used as part of the above method of modelling or can be used independently, there is provided an apparatus for separating products comprising:

a separation system for separating a first product from one or more others;

a conveyor for conveying the first product in a layer on the conveyor;

a coulter disk at the conveyor for rolling on the conveyor;

the coulter disk being mounted so as engage into the layer on the conveyor so that the coulter disk cuts into a surface of the layer;

the coulter disk having two side surfaces and an axle frame mounting the coulter disk for rotation such that the coulter disk rolls on the conveyor;

a source of electromagnetic radiation mounted within the coulter disk;

a detector responsive to electromagnetic radiation from material adjacent the coulter disk for emitting a signal related thereto, the detector being mounted at one side wall of the disk for rotation therewith;

the detector being mounted on the disk at a position thereon adjacent the edge;

and a control system for measuring constituents in the layer from electromagnetic radiation reflected from the material.

In one arrangement the products are separated by a press for extracting liquid from to form a cake. In this arrangement preferably the product is a source of manure and the apparatus operates for manufacturing manure cake from the source by extracting liquid. In some cases it may be necessary that the coulter disk is driven by a drive motor so as to rotate with the movement of the conveyor.

Where a depth measurement is required, preferably there is provided a controller responsive to the signal and adapted to calculate from the signal a first time when the sensor enters below the soil surface and a second time when the sensor departs the soil surface and to calculate from the first and second times the depth of penetration of the coulter in the soil.

Preferably the sensor detects a reflected light beam from a source adjacent the sensor. However other types of signals can be used for example ultrasonic signals. The sensor comprises a receptor of the light or other signal and a detector which generates an electrical output and it will be appreciated that the receptor may be located at the position on the disk to receive the signal whereas the detector itself may be located at the same receptor location or may be located remotely with the signal being communicated though a fiber or other transmission to the remote detector to generate the required output electrical signal for analysis.

In one embodiment, the sensor is part of an analysis system for example of the type described in the above patent arranged to provide data relating to the characteristics of the soil when the sensor is below the soil surface. In this embodiment the controller calculates the maximum depth of penetration of the coulter at the sensor so as to determine by the sensor characteristics of the soil at calculated depths.

In this arrangement preferably the sensor feeds the data to an analysis system to obtain an analysis of the characteristics of the soil from the surface to the maximum depth. These characteristics are then correlated with the actual detected depth as the depth of the sensor varies as the sensor rotates with the coulter.

The system may include an operator for changing a downward pressure on the disk so as change a maximum depth of penetration of the sensor.

In another embodiment, the controller calculates the depth of penetration of the coulter at the peripheral edge so as to calculate a depth of a furrow formed by the peripheral edge. This can be used in a seeding component for supplying seeds into a furrow formed by the peripheral edge of the disk where the depth of actual penetration is accurately calculated to better control depth of seeding. In this arrangement, an assembly for changing a downward pressure on the disk acts so as change the depth of the furrow and hence the depth of the supply of seeds or the seeding action.

### BRIEF DESCRIPTION OF THE DRAWINGS

One embodiment of the invention will now be described in conjunction with the accompanying drawings in which:

FIG. 1 is a vertical cross-sectional view of a coulter for measuring depth according to the present invention.

FIG. 2 is a side elevational view of the coulter of FIG. 1 for use in soil analysis.

FIG. 3 is a side elevational view of the coulter of FIG. 1 for use in seeding.

FIG. 4 is a schematic illustration of the components of the method according to the present invention.

FIG. 5 is a schematic side elevational view of a machine for incorporating slurry into the soil including the coulter disk of FIG. 1.

FIG. 6 is a cross-sectional view of the machine of FIG. 4 taken along the lines 6-6.

FIG. 7 is a schematic side elevational view of a harvesting machine including the coulter disk of FIG. 1.

FIG. 8 is a schematic side elevational view of a processing machine for separating two materials including the coulter of FIG. 1 for use in detecting the characteristics of one of the materials while carried on a conveyor.

FIG. 9 is a schematic side elevational view of a machine for cutting silage from a stack using the coulter of FIG. 1 for use in determining the characteristics of the silage in the stack as it is cut from the stack.

In the drawings like characters of reference indicate corresponding parts in the different figures.

### DETAILED DESCRIPTION

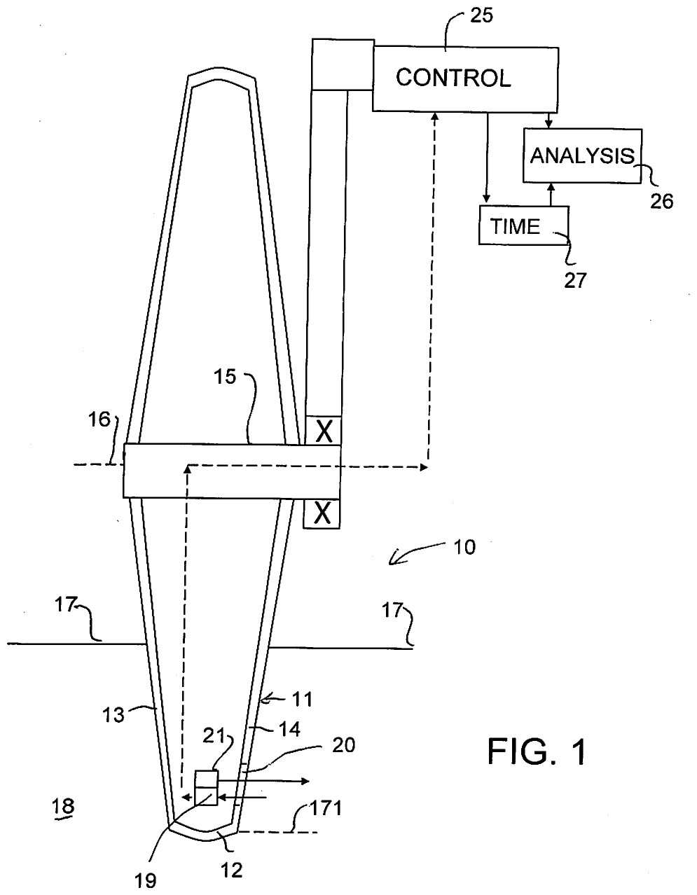

Turning firstly to the embodiment shown in FIGS. 1 to 3 there is shown a coulter disk and radiation detector of the type shown in the above patent which is used in a seeding action to accurately control the depth of the coulter and thus of the application of the seeds to the ground. Thus the soil coulter 10 for soil penetration includes a coulter disk 11 having a peripheral edge 12 and two spaced side walls 13, 14 extending from the peripheral edge toward a center of the disk. At the center is mounted a hub 15 mounting the disk for rotation about an axis 16 of the disk so that the peripheral edge 12 rotates in the soil and the coulter penetrates the soil to a depth below a surface 17 of the soil 18.

The arrangement herein uses basically the construction and arrangement as shown and described in the above prior patent, the disclosure of which is incorporated by reference or can be considered for additional disclosure of relevant matter.

The apparatus thus includes a source 19 mounted in a window 20 in one side wall 14 of the disk so that the source 19 is mounted on the disk for rotation therewith.

The sensor can comprise a detector 21 responsive to a reflected light beam from a source 19 or it can comprise a receptor such as an optical fiber which receives the light and transmits it to a remote detector.

The sensor is mounted on the disk at a position thereon adjacent the edge such that the sensor as the disk rotates is located above the surface of the soil during a first part of its rotation and is located below the surface during a second part of its rotation. The placement of the window as close as structurally possible to the edge or rim 12 is desirable to obtain maximum time of the detector within the soil

The sensor is adapted to issue a signal which changes in response to whether the sensor is above or below the soil surface. That is the reflected beam is significantly different in character depending on whether it is reflected from the soil or whether there is no external material to reflect when the window is above the surface.

A controller 25 is provided which is responsive to the signal and is adapted to calculate from the changes in the signal due to its position relative to the surface using a program 27 a first time stamp when the sensor enters below the soil surface and a second time stamp when the sensor departs the soil surface. Regardless of the rate of rotation of the disk, the proportion of time below the surface relative to the proportion above the surface allows the calculation by simple geometry from the first and second time stamps the depth of penetration of the coulter in the soil.

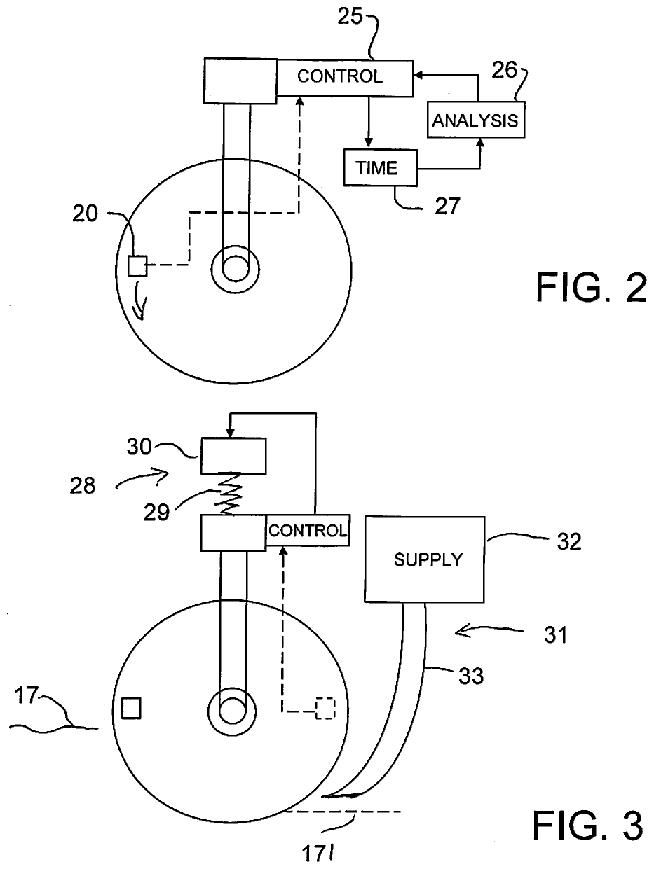

In FIGS. 1 and 2, the sensor feeds the data to an analysis system 26 to obtain an analysis of the characteristics of the soil from the surface to the maximum depth as the depth of the sensor varies as the sensor rotates with the coulter. The depth relative to a time between the two time stamps can be calculated and correlated to the characteristics as measured thus providing soil characteristics data at different depths between the surface and the maximum depth 171.

The system also includes an assembly 28 shown in FIG. 3 for changing a downward pressure on the disk applied by a spring 29 moved by an actuator 30 so as change a maximum depth of penetration of the sensor.

As explained above, the controller can calculate the maximum depth of penetration 171 of the coulter at the peripheral edge 12 so as to calculate a depth of a furrow formed by the peripheral edge. This can be used with a seeding component 31 including a seed supply 32 and a supply tube 33 for supplying seeds into the furrow formed by the peripheral edge of the disk. In this case the depth control pressure system 28 acts for changing a downward pressure on the disk so as change the depth of the furrow and hence the depth of the seeding action.

In FIGS. 1 to 3, therefore there is disclosed a soil coulter 10 for soil penetration comprising a disk having a peripheral edge 11 and two spaced side walls 12, 13 extending from the peripheral edge 11 toward a center of the disk at which a hub 15 mounts the disk for rotation about an axis 16 of the disk so that the peripheral edge 12 rotates in the soil and the coulter penetrates the soil to a depth below a surface of the soil 17. An operating component 31 is provided which in this embodiment comprises a seeding member 33 for operating in a furrow formed by the peripheral edge of the disk. A detector 21 responsive to electromagnetic radiation from material adjacent the coulter disk for emitting a signal related thereto is mounted at one side wall of the disk for rotation therewith. The detector is mounted on the disk at a position thereon adjacent the edge such that the sensor as the disk rotates is located above the surface of the soil during a first part of its rotation and is located below the surface during a second part of its rotation. The control system 25 is responsive to the signal to calculate the depth of penetration of the coulter in the soil and an assembly 28 is provided for changing a downward pressure on the disk 10 so as change a depth of penetration of the coulter disk and hence a depth of the operation. The sensor is also arranged to provide data relating to the characteristics of the soil when the sensor is below the soil surface and the controller calculates the maximum depth of penetration of the coulter at the sensor so as to determine by the sensor characteristics of the soil at calculated depths. The sensor feeds the data to an analysis system 26 to obtain an analysis of the characteristics of the soil from the surface to the maximum depth as the depth of the sensor varies as the sensor rotates with the coulter. In this embodiment the sensor detects a reflected beam from a source inside the disk.

In one mode of calculation, the controller 25 is adapted to calculate from the signal a first time when the sensor enters below the soil surface and a second time when the sensor departs the soil surface and to calculate from the first and second times the depth of penetration of the coulter in the soil.

In the operation shown in FIGS. 1 to 3, the operation which is effected at a required depth as measured by the system comprises seeding and the operating device is arranged to deposit seeds in the furrow from the duct 33.

However in arrangements not shown the operation can be related to other operations such as harvesting of underground crops such as root crops or other ground operation such as tillage equipment or excavation equipment.

In addition to the analysis of the constituents of the soil, there is also provided a temperature sensor 40 mounted on the coulter disk at a suitable location adjacent the edge so that it detects the soil temperature on an ongoing basis as the coulter moves across the ground.

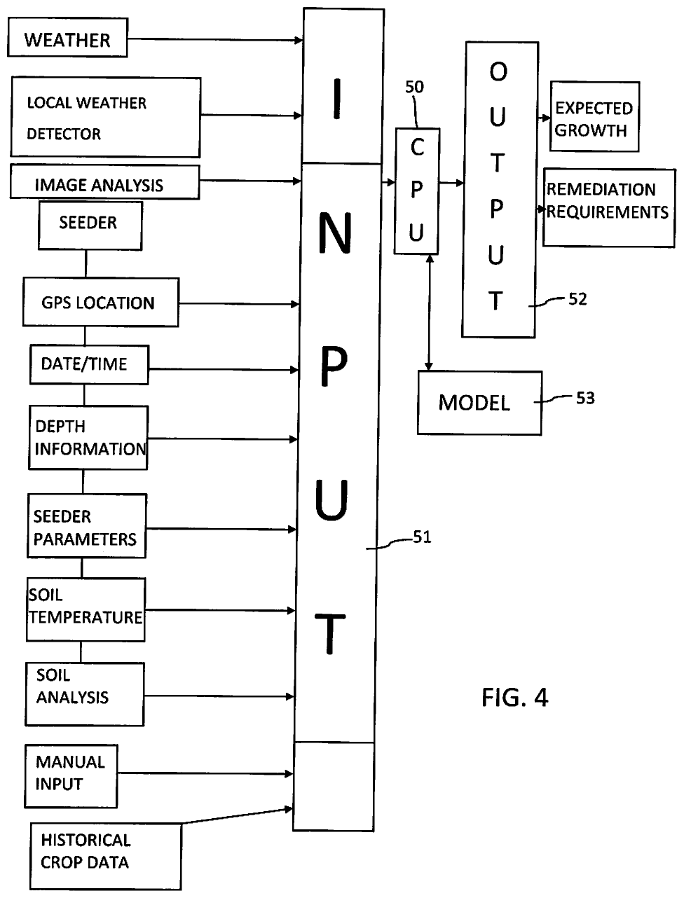

As shown in FIG. 4 there is provided a method for managing growth of crops in a soil bed comprising:

providing a computer processor 50 having an input 51 and output 52 for data which uses a crop growth model 53 which includes inputs from the data input and provides data output.

During a seeding operation of the seeder in FIGS. 1 to 3 for application of seeds to the soil bed the soil coulter operates as described for soil penetration by rolling the soil coulter along the soil bed.

The soil coulter is of the construction described above and includes the disk having a peripheral edge and two spaced side walls extending from the peripheral edge toward a center of the disk, a hub mounting the disk for rotation about an axis of the disk so that the peripheral edge rotates in the soil and the coulter penetrates the soil to a depth below a surface of the soil, a detector responsive to electromagnetic radiation from material adjacent the coulter disk for emitting a detector signal related to the radiation, the sensor being mounted at one side wall of the disk for rotation therewith. The detector is mounted on the disk at a position thereon adjacent the edge such that the sensor as the disk rotates is located above the surface of the soil during a first part of its rotation and is located below the surface during a second part of its rotation.

The system operates to obtain from the detector signal soil constituent data related to constituents of the soil bed during said seeding operation and operates for inputting the soil constituent data into the data input of the computer processor. The detector system includes the temperature sensor 40 which obtains signal data related to a temperature of the soil bed during said seeding operation and inputs the temperature data into the data input of the computer processor.

The seeder system also is arranged to enter into the input 51 data related to the following:

—a— the GPS location of the data obtained concerning the soil parameters obtained;

—b— the date and time of the seeding operation;

—c— the depth of the seeding operation;

—d— various information relating toe the seeding operation including seed types, seed parameters, rate of seeding etc.

A manual input is provided to allow the farmer to enter other information and data related to the seeding operation, the conditions of the ground and other mattes where such information is required for the model concerned.

The input also is arranged to enter during the growing season into the data input of the computer processor data related to weather conditions existing during the growing season at the soil bed, either obtained by commercially available weather data or by local sensors at the specific fields or areas where the seeding occurs.

The system operates using the crop growth model to generate from the soil constituent data, the temperature data and the data related to weather conditions output data indicative of a state of growth of the crop during the growing season. The model also provides an output indicative of data to apply at least one crop growth remediation product to the crop and/or the soil bed during the growth season.

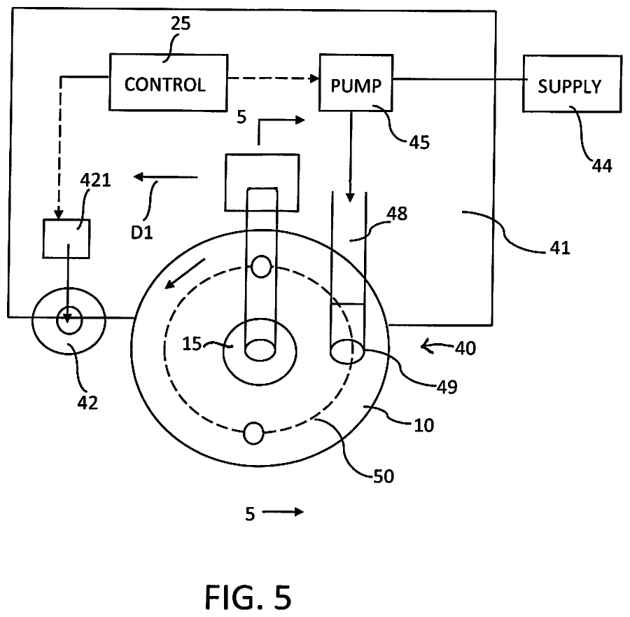

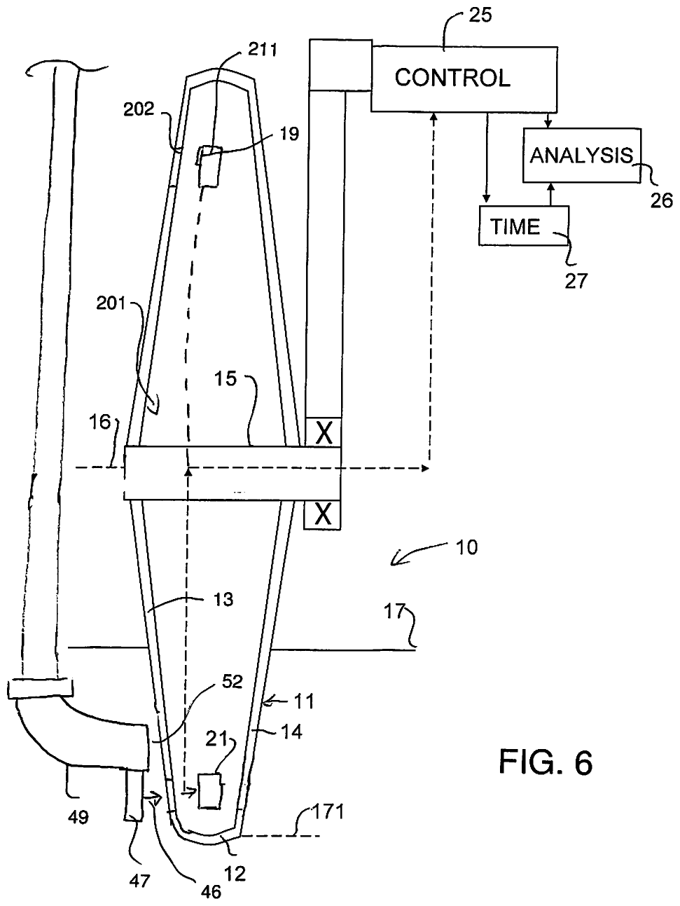

Turning mow to FIGS. 5 and 6 there is shown a schematic side elevational view of a machine for incorporating slurry into the soil including the coulter disk of FIG. 1 which is again of the type and construction shown in the above patent. In this arrangement the same coulter disk is used with a discharge duct 40 carried on the vehicle 41 mounted on ground wheels 42 for movement with the coulter disk arranged to apply the slurry onto the coulter disk 10 for incorporation into the soil. The disk 10 forms one of an array of such disks carried on suitable tool bars at spaced positions across the vehicle 41 each coulter having an associated duct 40. The vehicle includes a supply 45 of the slurry which communicates with a pump 45 for controlling the rate of supply of slurry to the coulter disks. Typically the supply comprises a hose pulled by the vehicle which carries the slurry from a lagoon some distance away from the field onto which the slurry is to be applied. However the supply can also comprise or include a tank which carries a volume of the slurry which is repeatedly re-filled from the lagoon.

In this case as shown in FIG. 5, the detector system is arranged such that the detector 21 receives electromagnetic radiation from the slurry at a part of the rotation of the coulter disk where the radiation indicated at 46 is transmitted through the slurry from a transmitter 47. In this embodiment the slurry from the supply 44 is applied by a pipe 48 and a guide mouth 49 onto a side surface 13 of the side wall of the coulter disk at which the detector 21 is located. The slurry is applied by the guide mouth portion 48 of the duct onto the side 13 of the coulter disk at a position behind the hub 15 relative to the direction D1 on a circular path 50 generated by the detector 21 as the coulter rotates in the direction D2. The source 46 of electromagnetic radiation is mounted on the duct 48 at a suitable location typically at the mouth 49 so as to be carried in fixed position pointing at the window 20 so as to transmit the electromagnetic radiation through the slurry and through the window to the detector for detecting the characteristics of the radiation passing through a known thickness of the slurry. As shown in FIG. 5, the slurry 52 is applied onto the coulter so that it runs along the side 13 downwardly to the bottom of the furrow cut by the coulter to be incorporated into the soil as the furrow closes behind the coulter. As the slurry 52 runs over the surface 13, the thickness of the stream of slurry remains substantially constant so that the radiation passing through it is modified or attenuated by the constituents in the slurry and particularly the total solids content which attenuates the radiation to a measurable amount. In this embodiment the detector system generally indicated at 201 is responsive to both reflected electromagnetic radiation from the source 19 inside the coulter disk 10 and to transmitted electromagnetic radiation from the source 47 outside the coulter disk. These can be located at a common transmitter receiver at a single window. However more preferably the coulter carries a first detector 211 responsive to electromagnetic radiation from the source 19 inside the coulter disk at a window 202 and a second detector 21 responsive to transmitted electromagnetic radiation from the source 47 outside the coulter disk passing through a window 20.

The vehicle is arranged to be driven by a drive system 421 at a variable ground speed operated by the control system 25. The slurry pump 45 is arranged to be driven by the control system 25 at a rate at least partly dependent on an analysis of the slurry obtained by the detector system. In this way the rate of application of nutrients measured by the sensing system to the ground can be detected and modified by measuring the constituents in the slurry in real time and controlling the ground speed and/or the pump speed to apply only a permitted maximum or desired rate of nutrient application per unit area of land. The analysis and rate control can be related to any measured characteristic but preferably is related to NPK content and/or total solids content.

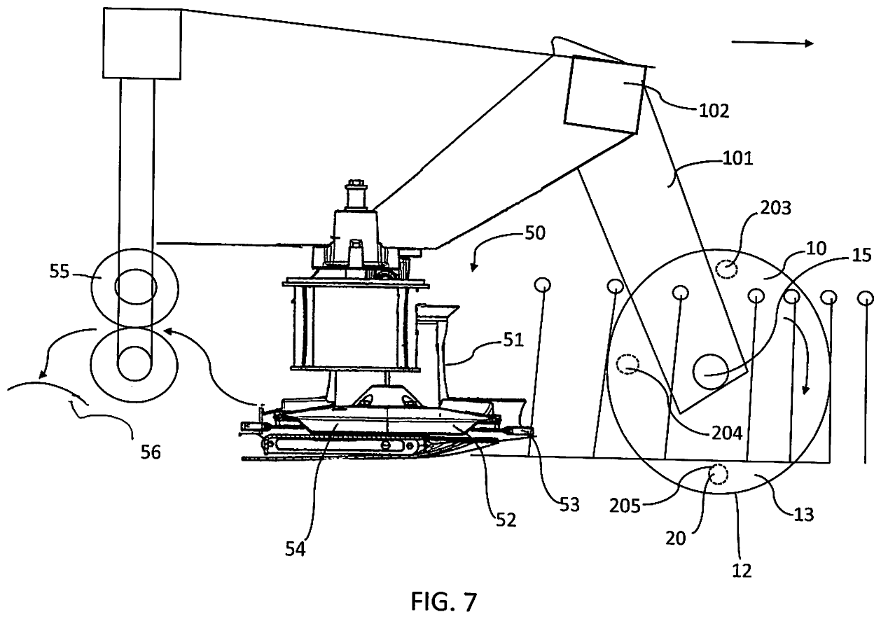

Turning now to FIG. 7 there is shown is a schematic side elevational view of a harvesting machine including the coulter disk 10 of FIG. 1 carried on an arm 101 mounted on a support beam 102 of the harvesting machine generally indicated at 50. The machine 50 includes one or more crop harvesting headers 51 for harvesting a standing crop on a growing medium and including a series of cutter disks 52 at spaced positions along a cutter bar 54 with each disk carrying blades 53. The coulter disk 10 is carried on the vehicle in front of the harvesting header 50.

Typically a single disk is provided even when the machine includes separate cutting headers, but in some cases each header may include its own disk.

As set out above, the coulter disk 10 has two side surfaces 13, 14 and an axle frame or hub 15 mounting the coulter disk for rotation such that the coulter disk rotates as it passes along the growing medium and cuts into the ground in front of the header. At least one detector system is provided comprising an electromagnetic radiation detector, a source of electromagnetic radiation as described before mounted at one side surface of the coulter disk and rotates with the coulter disk where the detector receives electromagnetic radiation after interaction with the material outside the window 20. As shown in FIG. 7, the window 20 and its associated detector are arranged such that the detector as it rotates with the coulter disk it receives electromagnetic radiation from the air above top of the standing crop as shown at position 203, from within the standing crop as shown at position 204 and from below the growing medium or soil as indicated at 205 and generates signals responsive thereto. The control system operates for receiving and analyzing the signals as before. This can be used to calculate from the signals from the air and from the standing crop the height of the standing crop. This can be used to calculate from the signals from the standing crop the density of the standing crop. This can be used to calculate from the signals from the standing crop constituents in the standing crop. This can be used to calculate from the signals from the growing medium constituents in the growing medium. The crop from the cutter bar 54 typically passes through conditioner rollers 55 to form a swath 56.

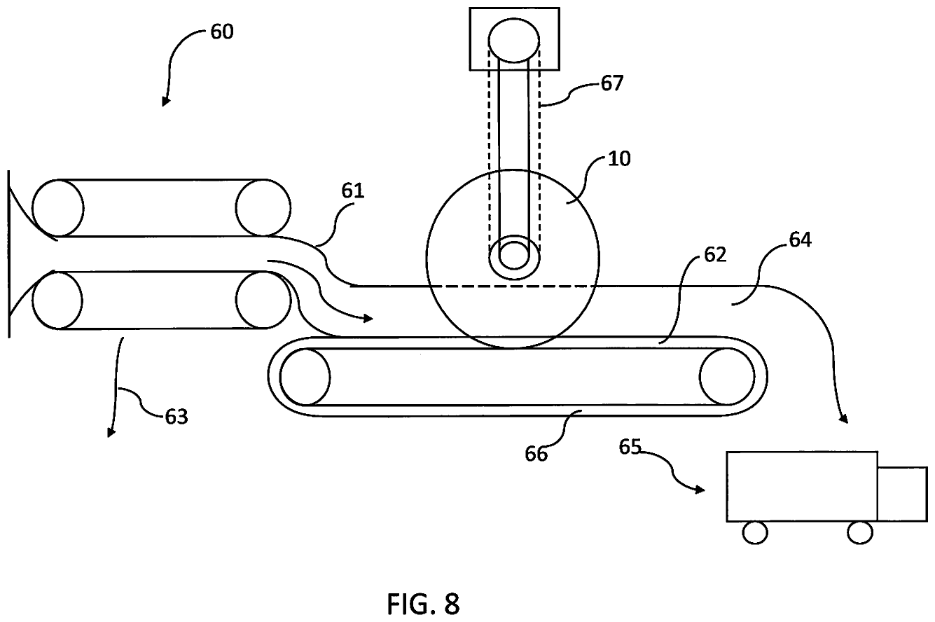

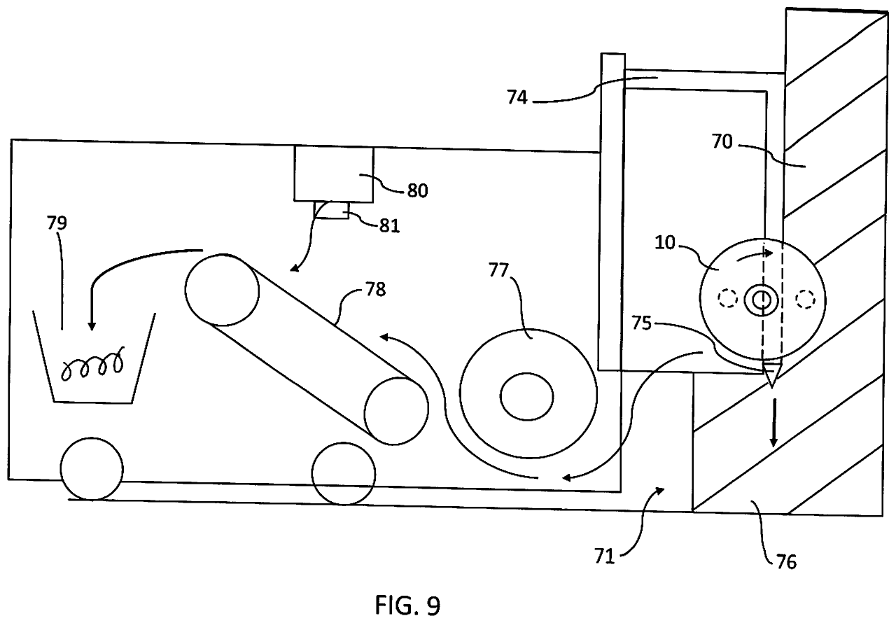

FIG. 8 is a schematic side elevational view of a processing machine for separating two materials including the coulter of FIG. 1 for use in detecting the characteristics of one of the materials while carried on a conveyor. In this arrangement there is provided a separation system 60 for separating a first product 61 from one or more others indicated at 63. In this embodiment the separation system comprises a press where liquid 63 is squeezed from a cake 61 but other processes can be used. In this arrangement the product 61 is fed onto a conveyor 62 for conveying the first product 61 in a layer 64 on the conveyor 62 to a transport system 65. In this arrangement the coulter disk 10 is mounted at or on the conveyor 62 for rolling on a belt 66 of the conveyor. The coulter disk is mounted so as engage into the layer 64 on the conveyor 62 so that the coulter disk cuts into a surface of the layer 64 optionally but not essentially down to the surface of the conveyor. As shown at 67 the coulter disk can be driven by a drive motor so as to rotate with the movement of the conveyor. However the rolling action on the conveyor belt or within the layer 64 may be sufficient to ensure continual rotation.

In one example the product is a source of manure and the apparatus operates for manufacturing manure cake from the source by extracting liquid.

FIG. 9 is a schematic side elevational view of a machine for cutting silage 70 from a stack 71 using the coulter 10 of FIG. 1 for use in determining the characteristics of the silage 70 in the stack as it is cut from the stack. In this arrangement there is provided a vehicle 73 for movement between the stack 71 of silage and an animal feed location. The vehicle has a cutting head 74 with a bottom cutting blade 75 for cutting into the stack 71 so as to extract a portion 76 of the stack for transportation. The cutting head 74 mounted on the vehicle for movement, which in this embodiment is vertical relative to the stack in a cutting action. A mixing roll 77 transfers the cut portion 76 from the cutting head onto a conveyor 78 for conveying the cut and extracted portion to a mixing and discharge hopper 79.

The coulter disk 10 is carried on the cutting head 74 for movement therewith in the cutting action and as shown in FIG. 9 is mounted just behind the sickle cutting blade 75 so that it detects the characteristics of the silage directly at the cutting blade to generate a real time output of the characteristics of the silage as it is being cut.

The vehicle can be arranged for mixing the conveyed and cut silage material on the conveyor 78 or at the hopper 79 with an additional material from a supply 80 wherein an amount of the additional material is controlled by a feed system 81 in response to the measured constituents or characteristics.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method for managing growth of crops in a soil bed comprising:
providing a computer processor having an input and output for data;
using the computer processor to operate a crop growth model which includes inputs from the data input and provides data output;
during a seeding operation for application of seeds to the soil bed operating a soil coulter for soil penetration by rolling the soil coulter along the soil bed, the soil coulter comprising:
a disk having a peripheral edge and two spaced side walls extending from the peripheral edge toward a center of the disk;
a hub mounting the disk for rotation about an axis of the disk so that the peripheral edge rotates in the soil and the coulter penetrates the soil to a depth below a surface of the soil;
a detector responsive to electromagnetic radiation from material adjacent the coulter disk for emitting a detector signal related to the radiation, the sensor being mounted at one side wall of the disk for rotation therewith;
the detector being mounted on the disk at a position thereon adjacent the edge such that the sensor as the disk rotates is located above the surface of the soil during a first part of its rotation and is located below the surface during a second part of its rotation;
obtaining from said detector signal soil constituent data related to constituents of the soil bed during said seeding operation and inputting said soil constituent data into the data input of the computer processor;
obtaining from said detector signal data related to a temperature of the soil bed during said seeding operation and inputting said temperature data into the data input of the computer processor;
during a growing season inputting into the data input of the computer processor data related to weather conditions existing during the growing season at the soil bed;
using the crop growth model to generate from the soil constituent data, the temperature data and the data related to weather conditions to generate output data indicative of a state of growth of the crop during the growing season;
and using the output data to apply at least one crop growth remediation product to the crop and/or the soil bed during the growth season.

2. The method according to claim 1 wherein the weather conditions are obtained from weather station data.

3. The method according to claim 1 wherein the weather conditions are obtained from local weather detectors.

4. The method according to claim 1 wherein further input data relates to historical crop yield data.

5. The method according to claim 1 wherein further input data relates visual images of a crop taken for example by satellite or drone.

6. The method according to claim 1 wherein the coulter carries a temperature sensor arranged to engage the soil as the coulter rotates in the soil bed.

7. The method according to claim 1 wherein other inputs include one or more of:
Historical weather data;
Site specific historical yield data.

8. The method according to claim 1 wherein there is provided a control system responsive to the signal to calculate the depth of penetration of the coulter in the soil and an assembly for changing a depth of application of the seeds to the soil bed depending on the measured depth.

9. The method according to claim 8 wherein a downward pressure on the disk is changed so as change a depth of penetration of the coulter disk and hence a depth of the application of the seeds.

10. The method according to claim 1 wherein said remediation product comprises any one of:
Water;
Fertilizer;
Chemical, such as fungicide, herbicide, insecticide.

11. The method according to claim 1 wherein said soil constituents comprise one or more of N, P, K, soil moisture, organic matter, pH, Electrical Conductivity (EC), sand and clay.

12. The method according to claim 1 wherein the sensor is arranged to provide data relating to the characteristics of the soil when the sensor is below the soil surface and the controller calculates the maximum depth of penetration of the coulter at the sensor so as to determine by the sensor characteristics of the soil at calculated depths.

13. The method according to claim 12 wherein the sensor feeds the data to an analysis system to obtain an analysis of the characteristics of the soil from the surface to the maximum depth as the depth of the sensor varies as the sensor rotates with the coulter.

14. The method according to claim 1 wherein the sensor detects a reflected beam.

15. The method according to claim 1 wherein the controller is adapted to calculate from the signal a first time when the sensor enters below the soil surface and a second time when the sensor departs the soil surface and to calculate from the first and second times the depth of penetration of the coulter in the soil.

16. The method according to claim 1 wherein the detector system is responsive to both reflected electromagnetic radiation from a source inside the coulter disk and to transmitted electromagnetic radiation from a source outside the coulter disk.

17. The method according to claim 16 wherein the coulter disk carries a first detector responsive to electromagnetic radiation from a source inside the coulter disk and a second detector responsive to transmitted electromagnetic radiation from a source outside the coulter disk.

18. The method according to claim 16 wherein the first detector is mounted at a first transparent window and the second detector is mounted at a second transparent window.

19. The method according to claim 1 wherein the detector includes a component mounted within the coulter disk and a transparent window at the side wall so as to receive electromagnetic radiation passing through the transparent window in the side wall of the coulter disk.

20. The method according to claim 1 there is provided an apparatus for applying a slurry to soil comprising:
a vehicle for movement across the soil;
a discharge duct carried on the vehicle for movement with the coulter disk arranged to apply the slurry onto the coulter disk for incorporation into the soil;
the detector system being arranged such that the detector receives electromagnetic radiation from the slurry at a part of the rotation of the coulter disk.

21. The method according to claim 1 there is provided a source of electromagnetic radiation mounted outside the coulter disk for transmitting the electromagnetic radiation inwardly to said detector.

22. The method according to claim 1 wherein the coulter disk and the detector are arranged such that the detector as it rotates with the coulter disk receives electromagnetic radiation from air above a top of the standing crop, from within the standing crop and from below the growing medium and generates signals responsive thereto and there is provided a control system for receiving and analyzing the signals.

23. The method according to claim 1 there is provided an apparatus for collecting and mixing silage comprising:
a vehicle for movement between a stack of silage and an animal feed location;
the vehicle having a cutting head for cutting into the stack so as to extract a portion of the stack for transportation, the cutting head being mounted on the vehicle for movement relative to the stack in a cutting action;
a conveyor for conveying the cut and extracted portion;
a coulter disk carried on the cutting head for movement therewith in the cutting action;
the coulter disk being mounted so as engage into the silage prior to or with the cutting action so that the coulter disk cuts into a surface of the silage to be cut;
the coulter disk having two side surfaces and an axle frame or hub mounting the coulter disk for rotation such that the coulter disk rotates as it moves along the silage with the cutting head;
a source of electromagnetic radiation mounted within the coulter disk;
a detector responsive to electromagnetic radiation from material adjacent the coulter disk for emitting a signal related thereto, the detector being mounted at one side wall of the disk for rotation therewith;
the detector being mounted on the disk at a position thereon adjacent the edge;
and a control system for measuring constituents in the silage from electromagnetic radiation reflected from the silage.

24. The method according to claim 1 there is provided an apparatus for separating products comprising:
a separation system for separating a first product from one or more others;
a conveyor for conveying the first product in a layer on the conveyor;
a coulter disk at the conveyor for rolling on the conveyor;
the coulter disk being mounted so as engage into the layer on the conveyor so that the coulter disk cuts into a surface of the layer;
the coulter disk having two side surfaces and an axle frame mounting the coulter disk for rotation such that the coulter disk rolls on the conveyor;
a source of electromagnetic radiation mounted within the coulter disk;
a detector responsive to electromagnetic radiation from material adjacent the coulter disk for emitting a signal related thereto, the detector being mounted at one side wall of the disk for rotation therewith;
the detector being mounted on the disk at a position thereon adjacent the edge;
and a control system for measuring constituents in the layer from electromagnetic radiation reflected from the material.
